(19) United States
(12) Patent Application Publication
(10) Pub. No.: US 2007/0275158 A1
(43) Pub. Date: Nov. 29, 2007

(54) C0G multi-layered ceramic capacitor

(76) Inventors: Michael S. Randall, Simpsonville, SC (US); Corey Antoniades, Seneca, SC (US); Daniel E. Barber, Fuquay-Varina, NC (US); Xilin Xu, Greenville, SC (US); James Beeson, Simpsonville, SC (US); Pascal Pinceloup, Simpsonville, SC (US); Abhijit Gurav, Greenville, SC (US); Tom Poole, Duncan, SC (US); Azizuddin Tajuddin, Laurens, SC (US); Ian Burn, Hockessin, DE (US)

Correspondence Address: NEXSEN PRUET, LLC, P.O. BOX 10648, GREENVILLE, SC, 29603, US

(21) Appl. No.: 11/809,967

(22) Filed: Jun. 4, 2007

Related U.S. Application Data
(62) Division of application No. 11/273,548, filed on Nov. 14, 2005.
(60) Provisional application No. 60/669,110, filed on Apr. 7, 2005.

(51) Int. Cl. B05D 5/12

(52) U.S. Cl. 427/79

(57) ABSTRACT

A dielectric ceramic composition in a multilayer ceramic capacitor having a composition of formula:
((CaO)ₜ(SrO)₁₋ₜ(ZrO₂)ᵥ(TiO₂)₁₋ᵥ)_{1-s-x-y-z}AₛEₓG_{y}H_{z} wherein: A is a transition metal oxide; E is an oxide of a group III or IV element; G is an oxide of a group II element; H is an oxide of a lanthamide; t is 0.50 to 0.90; v is 0.8 to 1.0; s is 0.0001 to 0.08; x is 0 to 0.08; y is 0 to 0.20; and z is 0 to 0.20.

This application relates to ceramic capacitors having either a noble metal or base metal electrode which conforms to the Electronics Industry Alliance (EIA) Standard No. 198-1-F-2002 for temperature coefficient standard C0G. This application is related to U.S. Provisional Patent Ser. No. 60/669,110, filed Apr. 5, 2005 (attorney docket number 31433/78); and U.S. patent Ser. No. 11/146,847 filed Jun. 7, 2005 (attorney docket number 31433/77).

### FIELD OF THE INVENTION

### Background and Prior Art

C0G capacitors have very low temperature drift Temperature Coefficient of Capacitance (TCC) (≦+/−30 ppm/° C.). Typically, the primary components of the ceramic include magnesium titanates or barium neodymium titatanate based materials.

The use of base metal electrodes such as Ni, Cu, and 80 Ni:20 Cu for capacitors offer significant material cost advantages over noble metals or precious metal electrodes such as Pt, Pd, Au, Ag and combinations thereof. Ni and Cu are conductive, comparatively inexpensive metals which, in pure form, are not facilely oxidized. Both can be deposited as electrodes using screen printing processes on the same equipment conventionally used for depositing noble metals. Ni has a higher melting point (Ni mp 1450° C.; Cu mp 1083° C.-Weast Handbook of Chemistry & Physics, 46^{th} edition) and is preferred for multi-layered ceramic capacitors (MLCC) fired at higher temperatures.

While the ceramic dielectrics of this invention may be used with precious metals to obtain C0G MLCC capacitors (which may be fired in oxidative environments), BME capacitors are preferred.

Numerous compositions have been disclosed for non-reducing type dielectric ceramic compositions including U.S. Pat. Nos. 5,204,301; 6,118,648; 6,295,196; 6,396,681; 6,327,311; 6,525,628; 6,572,793; 6,645,897; and, 6,656,863, as well as published patent application numbers US 2005 0111163; US 200 30186802 and US 2004/0220043. These disclosures are directed to various combinations of Ca, Sr, Zr, Ti and Ba oxides with or without limited amounts of dopant oxides or alkaline, alkaline earth and rare earth metals wherein individual precursors are fired to form a ceramic matrix. These ceramics, though beneficial, are still inferior with regards to C0G performance. There has been an ongoing effort in the art to provide a capacitor with improved properties and, specifically, to ceramics which can provide an improved capacitor.

### BRIEF DESCRIPTION OF THE INVENTION

It is a first objective of this invention to provide a base metal electrode multilayer ceramic capacitor (BME MLCC) device having a high CV (capacitance per unit volume).

It is a second objective of this invention to produce a MLCC device which meets the C0G specification for Temperature Coefficient of Capacitance (≦+/−30 ppm/° C.).

It is a further objective of this invention to provide a MLCC capacitor meeting C0G specifications which can be produced at a price competitive with lower performing devices such as those meeting C0H, C0J, C0K, SL, R2J, X7R, etc., and lower specifications, and which meet industry standards for reliability.

These and other objectives may be met using ceramic compositions according to formula (I).
((CaO)ₜ(SrO)₁₋ₜ(ZrO₂)ᵥ(TiO₂)₁₋ᵥ)_{1-s-x-y-z}AₛEₓG_{y}H_{z} (1)
In Formula 1 A is a transition metal oxide preferably selected from Cu, Mn, Mo, W, Co, Ta, Sc, Y, Yb, Hf, V, Nb, Cr and combinations thereof. Most preferably A is manganese oxide. E is an oxide of a group III or IV element preferably selected from Ge, Si, Al, Ga, B and combinations thereof. G is an oxide of a group II element preferably selected from Sr, Mg, Ba and combinations thereof. H is an oxide of a lanthamide preferably selected from La, Lu, Ce, Eu, Ho, Er, Yb and combinations thereof. Subscripts have the following values: t is 0.50 to 0.90; s is 0.0001 to 0.08; v is 0.8 to 1.0; x is 0 to 0.08; y is 0 to 0.20; and z is 0 to 0.20.

Yet another embodiment is provided in a method for forming a capacitor comprising:

milling to a D50 of between 0.30 μm and 0.50 μm a material with a composition of:
(CaO)ₜ(SrO)₁₋ₜ(ZrO₂)ᵥ(TiO₂)₁₋ᵥ
wherein t is 0.50 to 0.90; and
v is 0.8 to 1.0;
thereby forming a first component (C1);

milling MnO₂ or MnCO₃ or other oxidized form of Mn to a D50 of less than 0.50 μm thereby forming a second component (C2);

milling SiO₂ to a D50 of less than 0.50 μm thereby forming a third component (C3);
combining the first component, the second component and the third component with a solvent in a ratio C1_{1-α-β}C2_{α}C3_{β} wherein:
   α is 0.001 to 0.08; and
   β is 0.001 to 0.08;
   thereby forming a coating solution;

applying the coating solution to a tape at a coating weight of 10-40 g/m²;

drying the coating solution to form a green coating;
depositing an ink comprising electrode material and a filler over the green coating to form a capacitor blank;
dicing the capacitor blank to form singular green multilayer chips;
firing the singular green multilayer chips in an atmosphere with a PO₂ of 10⁻⁶ to 10⁻¹⁶; and
forming terminals in electrical contact with said electrode material.

### BRIEF DESCRIPTION OF THE DRAWINGS

FIG. 1 is a side view of a multilayer ceramic capacitor according to this invention.

FIGS. 2-4 are three-dimensional plots showing the effects of dopant content on capacitance of a representative ceramic composition.

FIGS. 5-7 are three-dimensional plots showing the effects of firing temperature on the capacitance of a representative ceramic composition.

FIGS. 8-10 are three-dimensional plots showing the effects of composition on the ultimate break-down voltage (UVBD) of a representative ceramic composition.

### DETAILED DESCRIPTION OF THE INVENTION

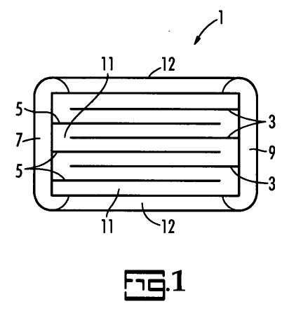

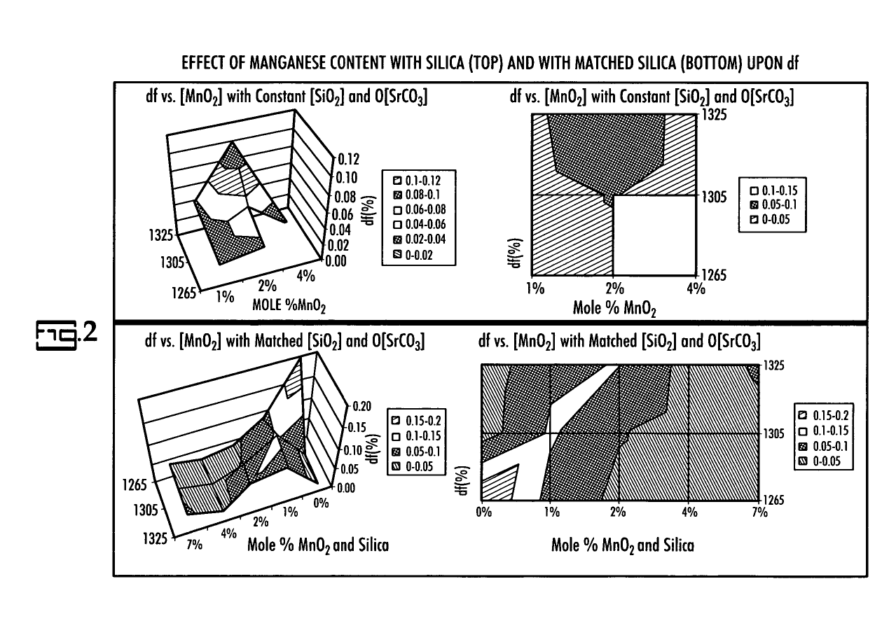

The use of base metals as the conductive metal in a capacitor electrode allow the performance in the capacitor to be maintained while decreasing materials costs. FIG. 1 is a side view of a conventional multi-layer or stacked ceramic capacitor 1. Conductive plates 3, 5 serve as electrodes and are connected to terminations 7, 9 in alternating order. The electrodes are separated or isolated by dielectric ceramic 11. A resin, 12, encases a portion of the capacitor as known in the art.

The electrodes 3, 5 may be made from any conductive material but are typically noble metals such as Pt, Pd, Au or Ag. Since noble metals are difficultly oxidized, when the green stacked plates are fired, high temperatures and an oxidizing atmosphere may be used, and a ceramic having a high dielectric constant is obtained. Good temperature coefficients of capacitance may be obtained.

The use of base metals requires modifications in the composition of the ceramic and in the conditions of firing. Formulations are desired which have a low Temperature Coefficient of Capacitance (TCC), preferably meeting the EIA C0G standard (≦+/−30 ppM/° C.).

Preferred ceramics are defined according to formula (1).
((CaO)ₜ(SrO)₁₋ₜ(ZrO₂)ᵥ(TiO₂)₁₋ᵥ)_{1-s-x-y-z}AₛEₓG_{y}H_{z} (1)
In formula (1) A is a transition metal oxide preferably selected from Cu, Mn, Mo, W, Co, Ta, Sc, Y, Yb, Hf, V, Nb, Cr and combinations thereof; Most preferably A is manganese oxide. E is an oxide of a group III or IV element preferably selected from Ge, Si, Al, Ga, B and combinations thereof. G is an oxide of a group II element preferably selected from Sr, Mg, Ba and combinations thereof. H is an oxide of a lanthamide preferably selected from La, Lu, Ce, Eu, Ho, Er, Yb and combinations thereof. Subscripts in formula (I) have the following values: t is 0.50 to 0.90; s is 0.0001 to 0.08; v is 0.8 to 1.0; x is 0 to 0.08; y is 0 to 0.20; and z is 0 to 0.20.

The compound of formula (I) is unique in that a precursor material defined as (CaO)ₜ(SrO)₁₋ₜ(ZrO₂)ᵥ(TiO₂)₁₋ᵥ is mixed with an appropriate amount of a precursor of a dopant oxide. The method typically employed in the art includes the firing of a mixture of oxide precursors, such as carbonates, thereby forming a single phase of a primary material and secondary phases dependant on ratios of reactants and the phase compositions. Oxide precursors are materials which are an oxide after heating as described herein. Particularly preferred oxide precursors include oxides, carbonates, oxalates, peroxides, acetates, nitrates and the like. In the present application the primary phase is predetermined as the CaSrZrTi material and dopants are added thereto which, presumably, form phases differing from that formed by firing precursors of the oxides of calcium, strontium, zirconium, titanium and dopants. As well known to those of skill in the art minor variations in composition, either globally or locally, can result in phases which are neither predictable nor controllable. Therefore, with the prior art techniques there may be unintentional secondary phases formed and these vary from batch to batch and therefore from capacitor to capacitor. The material prepared herein provides greatly improves the consistency of the ceramic and provides unpredictable advantages with regards to C0G relative to ceramic materials formed in accordance with the prior art.

A particularly preferred formulation is provided with a base material of CaO_{0.7}SrO_{0.3}(ZrO₂)_{0.97}(TiO₂)_{0.03} which is preferably doped with one or more of MnO, MnO₂, MnCO₃, SiO₂, SrO, SrCO₃. All formulations are milled at the slurry or slip stage in a suitable milling solution such as water, alcohol, toluene or a combination thereof, or dihydroterpinol (DHT) or other suitable milling solutions using suitable media to a size of D₅₀ ca.<0.5 μm or less. The slip is spread on a carrier film material using a doctor blade. The electrodes are preferably deposited via screen printing using a conductive ink filled with the base formulation or other as suitable. The chips are diced, burned out and fired in a reducing atmosphere of PO₂ equal to about 10⁻⁸ or less. Soak temperatures from 1245° C. to 1350° C. may be selected.

COG ceramic capacitors can be made using the mole % of MnO₂, SiO₂ and SrCO₃ or SrO present in amounts between 0 and ˜8 mole %.

The preparation of laminated ceramic capacitors are well documented and the present invention does not alter the manufacturing process to any significant degree relative to standard procedures known in the art.

As an example of a manufacturing process, ceramic slurry is prepared by blending and milling the ceramic compounds described herein with a dispersant in either water or an organic solvent such as, for example, ethanol, isopropanol, toluene, ethyl acetate, propyl acetate, butyl acetate, mineral spirits or other suitable hydrocarbon liquid, or a blend thereof. After milling a ceramic slip is prepared for tape-casting by adding a binder and a plasticizer to control rheology and to give strength to the tape. The obtained slip is then processed into a thin sheet by tape-casting by coating at a ceramic coating weight of about 10-40 g/m² exclusive of binders and solvents. After drying the sheet, a multiplicity of electrodes are patterned on the sheet by using, for example, a screen-printing method to form printed ceramic sheet.

A laminate green body is prepared by stacking onto a substance such as polycarbonate, polyester or a similar method: 1) a certain number of unprinted ceramic sheets representing the bottom covers, then 2) a certain number of printed ceramic sheets in alternate directions so as to create alternating electrodes that terminate at opposing ends, and 3) a certain number of unprinted ceramic sheets representing the top covers. Variations in the stacking order of the printed and unprinted sheets can be used with the dielectric material of this invention. The stack is then pressed at between 20° C. and 120° C. to promote adhesion of all laminated layers.

The laminated green body is then cut into individual green chips.

The green chip is heated to remove the binder. The binder can be removed by heating at about 200-400° C. in atmospheric air or neutral or slightly reducing atmosphere for about 0.5 to 48 hours.

The dielectric is then sintered in a reductive atmosphere with an oxygen partial pressure of 10⁻⁶ to 10⁻¹⁶ atm at a temperature not to exceed 1350° C. The preferred temperature is about 1,200 to 1,325° C. After sintering the dielectric is reoxidized by heating to a temperature of no more than about 1,100° C. at an oxygen partial pressure of about 10⁻⁵ to 10⁻¹⁰ atm. More preferably, the reoxidation is done at a temperature of about 800 to 1,100° C. The material resulting from this stage is typically referred to as a sintered chip.

The sintered chip is subjected to end surface grinding by barrel or sand blast, as known in the art, followed by transferring outer electrode paste to form the external electrodes. Further baking is then done to complete the formation of the outer electrodes. The further baking is typically done in nitrogen or slightly oxidizing atmosphere at a temperature of about 600-1000° C. for about 0.1 to 1 hour.

Layers of nickel and tin or other suitable solder composition can then be plated on the outer electrodes to enhance solderability and prevent oxidation of the outer electrodes.

### EXAMPLE 1

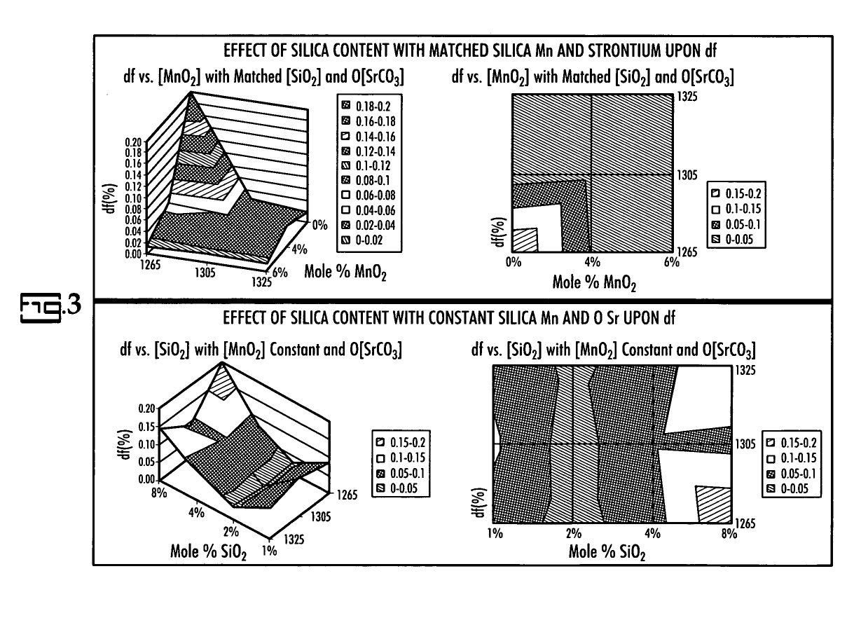

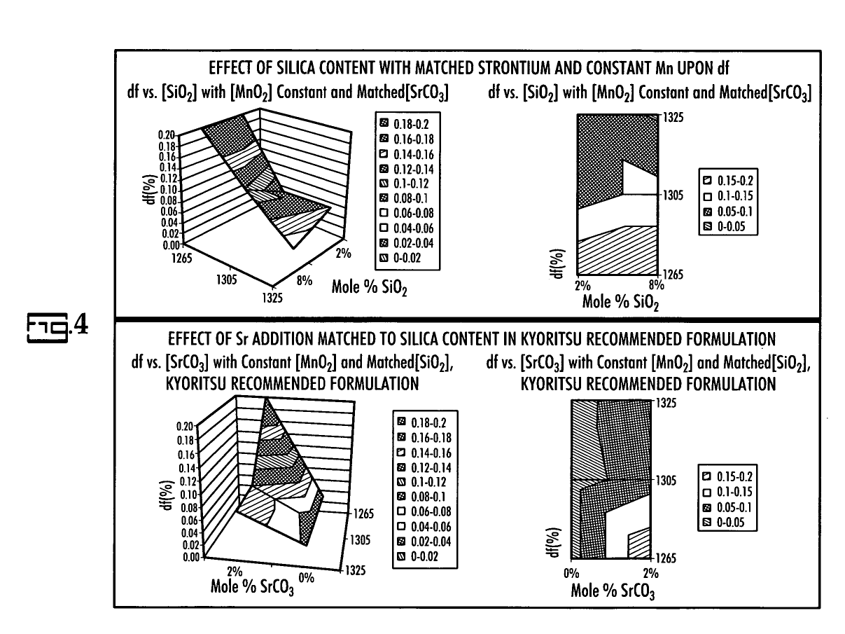

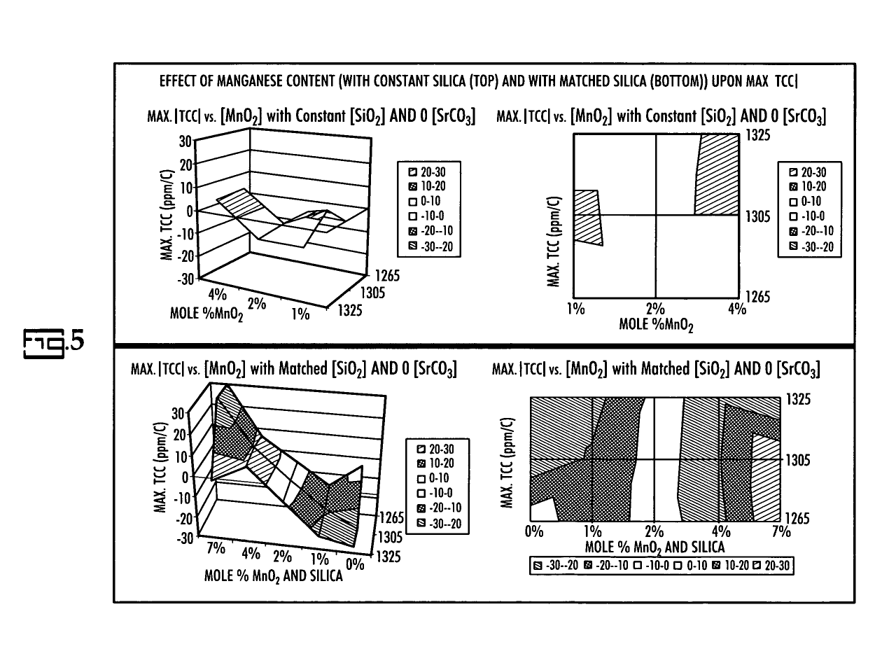

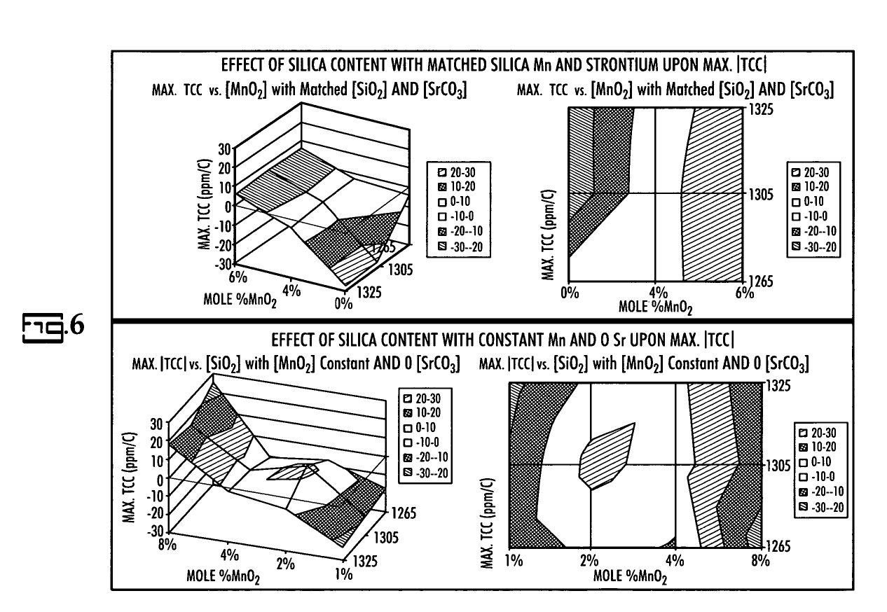

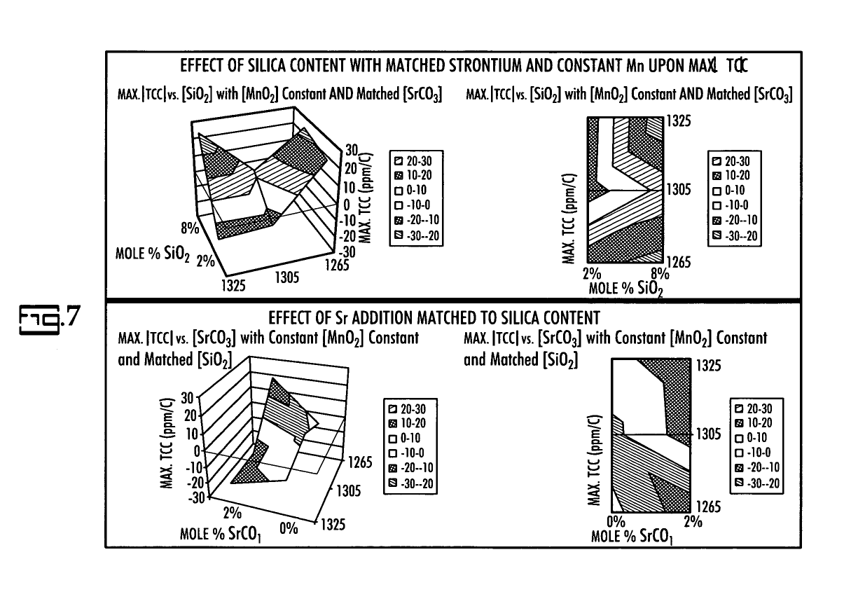

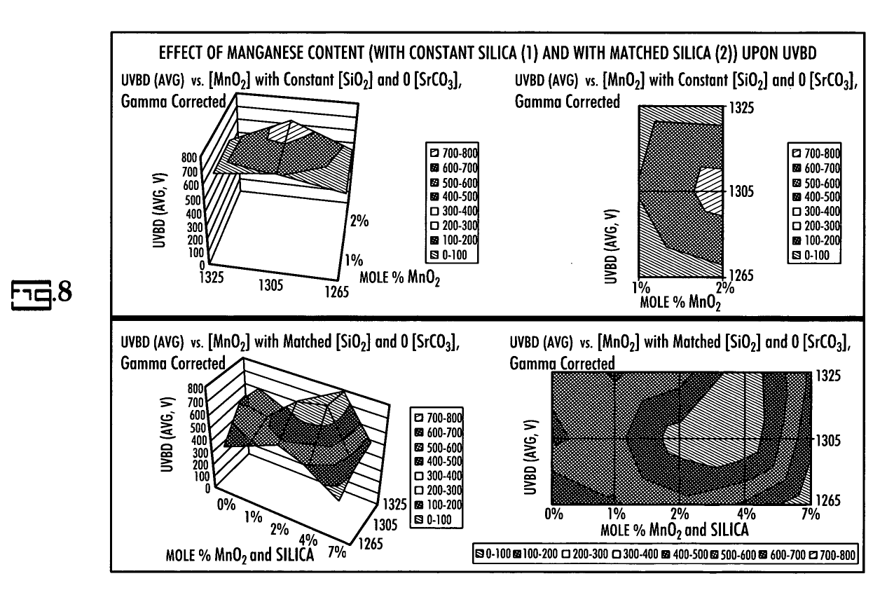

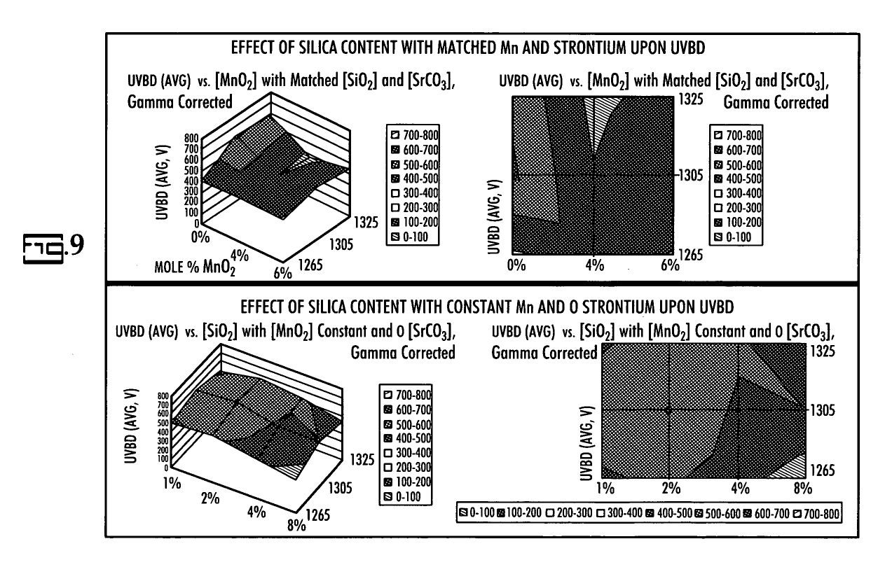

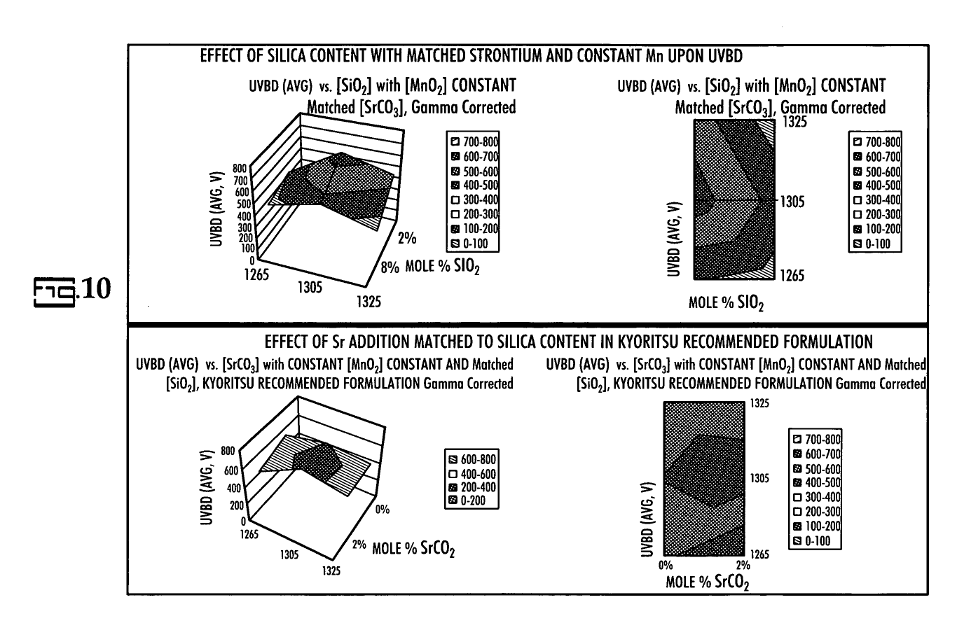

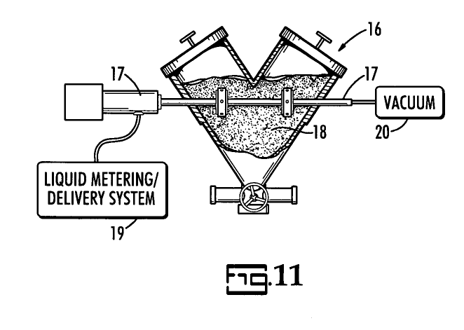

A base formulation of CaO_{0.7}SrO_{0.3}(ZrO₂)_{0.97}(TiO₂)_{0.03} was mixed into the milling solution and milled in an horizontal bead mill with 1 mm spherical media to D₅₀=0.35 μm. Separately MnO₂ (J. T. Baker) and SiO₂ (Degussa Aerosil OM50) were mixed with milling solution and milled to less than ca 0.4 μm using 1 mm media in a jar mill. The MnO₂ (0.972%) and SiO₂ (2.170%) were mixed with the base formulation (96.658%). Tapes were coated via a tape caster using a doctor blade for a target coating weight of 30 g/m². The Ni electrodes were deposited via screen printing using suitable ink containing 15% of milled base formulation as filler. After dicing to achieve singular green multilayer chip devices, the singular MLCC have the organic materials removed via a thermal burnout process. The chips were fired at 1265° C., 1305° C. and 1325° C. respectively, in an oxygen depleted atmosphere of about PO₂=10⁻⁶ to 10⁻¹⁶. The chips were corner rounded and terminated with a suitable copper thick film termination. The capacitance values were measured. Similar chips were made with 0.1925% and 3.7787% MnO₂ (same SiO₂ amount). Comparisons of the physical properties as a function of composition and firing temperature are shown in FIGS. 2-10.

Capacitors of the type disclosed herein may be substituted for polymer film capacitors, Al, Nb and Ta capacitors, or for existing noble metal or base metal electrode based MLCC capacitors. Both lower costs and superior TCC are possible in this family of formulations.

The invention has been disclosed in consideration of specific examples which do not limit the scope of the invention. Modifications apparent to one having skill in the art subsumed within the scope of the invention.

1-15. (canceled)

16-23. (canceled)

24. A capacitor formed by the method of milling to a D50 of between 0.30 μm and 0.50 μm a material comprising:
(CaO)ₜ(SrO)₁₋ₜ(ZrO₂)ᵥ(TiO₂)₁₋ᵥ
wherein t is 0.50 to 0.90; and
v is 0.8 to 1.0,
thereby forming a first component (C1);
milling MnO₂, MnCO₃ or another oxidized form of Mn to a D50 of less than 0.50 μm thereby forming a second component (C2);
milling SiO₂ to a D50 of less than 0.50 μm thereby forming a third component (C3);
combining said first component, said second component and said third component with a solvent in a ratio C1_{1-α-β}C2_{α}C2_{β} wherein:
α is 0.001 to 0.08; and
β is 0.001 to 0.08;
thereby forming a coating solution;
applying said coating solution to a tape at a ceramic coating weight of 10-40 g/m²;
drying said coating solution to form a green coating;
depositing an ink comprising electrode material and a filler over said green coating to form a capacitor blank;
dicing said capacitor blank to form singular green multilayer chips;
firing said singular green multilayer chips in an atmosphere with a PO₂ of 10⁻⁶ to 10⁻¹⁶; and
forming terminals in electrical contact with said electrode material.

25. The capacitor according to claim 24 which has a temperature coefficient of capacitance of ≦+/−30 ppm/° C.
